(19) United States
(12) Patent Application Publication
(10) Pub. No.: US 2026/0167555 A1
(43) Pub. Date: Jun. 18, 2026

(54) SINGLE-DRAW MULTI-STEP MULTI-FURNACE FABRICATION OF HOLLOW-CORE FIBERS

(71) Applicant: University of Central Florida Research Foundation, Inc., Orlando, FL (US)

(72) Inventors: Rodrigo Amezcua-Correa, Orlando, FL (US); Jose Enrique Antonio-Lopez, Orlando, FL (US); Stephanos Yerolatsitis, Orlando, FL (US); Joseph Wahlen, Orlando, FL (US)

(21) Appl. No.: 19/127,365

(22) PCT Filed: Nov. 6, 2023
(86) PCT No.: PCT/US2023/036878

§ 371 Date: May 5, 2025

Related U.S. Application Data
(60) Provisional application No. 63/422,776, filed on Nov. 4, 2022.

(51) Int. Cl. C03B 37/029; C03B 37/025; C03B 37/027; C03B 37/03

(52) U.S. Cl. CPC C03B 37/029; C03B 37/0253; C03B 37/02781; C03B 37/032; C03B 2203/16; C03B 2203/42; C03B 2205/10

(57) ABSTRACT

A multi-stage draw tower may include two or more draw furnaces associated with two or more draw stages and one or more pullers to draw the preform through the two or more draw stages. The two or more draw furnaces and the one or more pullers are configured to progressively decrease a diameter of a preform through one or more intermediate diameters to provide a fiber with a selected final diameter in a single draw process. The fiber may correspond to a hollow-core optical fiber or a solid-core fiber.

### CROSS-REFERENCE TO RELATED APPLICATION

The present application claims priority to U.S. Provisional Application Ser. No. 63/422,776, filed Nov. 4, 2022, entitled SINGLE-DRAW MULTI-STEP MULTI-FURNACE FABRICATION OF HOLLOW-CORE FIBERS, naming Rodrigo Amezcua-Correa, Jose Antonio-Lopez, Joseph Wahlen, and Stephanos Yerolatsitis as inventors, which is incorporated herein by reference in the entirety.

### GOVERNMENT LICENSE RIGHTS

This invention was made with Government support under Grant No. AFRL: FA86511820019 awarded by the Air Force Research Laboratory (AFRL) and Grant No. W911NF1910426 awarded by the Army Research Office (ARO). The Government has certain rights in this invention.

### TECHNICAL FIELD

The present disclosure relates generally to the fabrication of optical fibers and, more particularly, to the fabrication of hollow-core fibers using single-draw multi-furnace techniques.

### BACKGROUND

Hollow-core optical fibers that guide light primarily in air offer various benefits over traditional glass fibers such as, but not limited to, high average and peak power capability, high damage thresholds, low latency, and relatively low non-linearities. However, fabrication of hollow-core fibers presents different challenges than traditional glass fibers, particularly when scaling to long lengths. There is therefore a need to develop systems and methods to address these deficiencies.

### SUMMARY

A multi-stage draw tower is disclosed in accordance with one or more illustrative embodiments. In some embodiments, a multi-stage draw tower includes two or more draw furnaces associated with two or more draw stages. In some embodiments, a multi-stage draw tower includes one or more pullers to draw the preform through the two or more draw stages, where the two or more draw furnaces and the one or more pullers are configured to progressively decrease a diameter of a preform through one or more intermediate diameters to provide a fiber with a selected final diameter in a single draw process.

In some embodiments, the multi-stage draw tower includes a pressure system to apply pressure to the preform prior to a first of the two or more draw stages. In some embodiments, the pressure system applies different pressures to different portions of the preform.

In some embodiments, the multi-stage draw tower includes one or more monitoring sensors to generate monitoring data associated with at least one of the preform or the fiber.

In some embodiments, the multi-stage draw tower includes a controller including one or more processors configured to execute program instructions causing the one or more processors to perform various steps such as, but not limited to, receive the monitoring data from the one or more monitoring sensors or control, via control signals, at least one of the two or more draw furnaces or the one or more pullers based on the monitoring data. In some embodiments, control, via control signals, at least one of the two or more draw furnaces or the one or more pullers based on the monitoring data corresponds to controlling at least one of one or more pullers based on the monitoring data to maintain a selected diameter of at least one of the preform or the fiber after a selected draw stage.

In some embodiments, the monitoring data includes at least one of a diameter, a temperature, a draw speed, a tension, or a geometry. In some embodiments, the monitoring data includes pressure applied to the preform via a pressure system.

In some embodiments, the multi-stage draw tower includes a spool to receive the fiber from the two or more draw stages.

In some embodiments, the multi-stage draw tower includes a coating system to coat the fiber with one or more coatings.

In some embodiments, a first draw furnace of the two or more draw furnaces is configured to accept the preform, wherein an allowable width of the preform accepted by the first draw furnace is equal to or greater than two centimeters, ten centimeters, or more.

In some embodiments, a length of the optical fiber drawn by the two or more draw stages from the preform is equal to or greater than five kilometers, fifty kilometers, or more.

A method is disclosed, in accordance with one or more illustrative embodiments. In some embodiments, the method includes placing a preform in a multi-stage draw tower. In some embodiments, the multi-stage draw tower includes two or more draw furnaces associated with two or more draw stages and one or more pullers to draw the preform through the two or more draw stages. In some embodiments, the method includes performing a single draw process on the preform with the multi-stage draw tower, where the two or more draw furnaces and the one or more pullers are configured to progressively decrease a diameter of a preform through one or more intermediate diameters to provide a fiber with a selected final diameter in the single draw process.

In some embodiments, the method includes applying pressure to the preform prior to a first of the two or more draw stages with a pressure system. In some embodiments, applying pressure to the preform prior to the first of the two or more draw stages with the pressure system includes applying different pressures to different portions of the preform with the pressure system.

In some embodiments, the method includes generating monitoring data associated with at least one of the preform or the fiber with one or more monitoring sensors. In some embodiments, the method includes receiving the monitoring data from the one or more monitoring sensors and controlling, via control signals, at least one of the two or more draw furnaces or the one or more pullers based on the monitoring data. In some embodiments, controlling, via control signals, at least one of the two or more draw furnaces, the one or more pullers, or a pressure system based on the monitoring data includes controlling at least one of one or more pullers based on the monitoring data to maintain a selected diameter of at least one of the preform or the fiber after a selected draw stage. In some embodiments, the monitoring data includes at least one of a diameter, a temperature, a draw speed, a tension, or a geometry.

In some embodiments, the method includes coating the fiber with one or more coatings with a coating system.

A hollow-core optical fiber (HCF) is disclosed in accordance with one or more illustrative embodiments. In some embodiments, the HCF includes a cladding and one or more walled features within an interior cavity of the cladding, where the one or more walled features are configured to guide light of one or more selected wavelengths within a hollow central region of the interior cavity based on anti-resonance. In some embodiments, the hollow-core optical fiber is formed by the steps of placing a preform in a multi-stage draw tower, and performing a single draw process on the preform with the multi-stage draw tower, where the two or more draw furnaces and the one or more pullers are configured to progressively decrease a diameter of a preform through one or more intermediate diameters to provide the hollow-core optical fiber with a selected final diameter in the single draw process. In some embodiments, a width of the preform used to generate the HCF is equal to or greater than two centimeters, ten centimeters, or more. In some embodiments, a length of the HCF is equal to or greater than five kilometers, fifty kilometers, or more.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF DRAWINGS

The numerous advantages of the disclosure may be better understood by those skilled in the art by reference to the accompanying figures.

FIG. 1 is a block diagram of a multi-stage draw tower, in accordance with one or more embodiments of the present disclosure.

FIG. 2A is a simplified schematic of a multi-stage draw tower including three draw stages, in accordance with one or more embodiments of the present disclosure.

FIG. 2B is a simplified schematic of a multi-stage draw tower including four draw stages to reach a final diameter of a fiber, where the draw stages are not vertically aligned, in accordance with one or more embodiments of the present disclosure.

FIG. 3A is a cross-sectional view of a nested anti-resonant hollow-core fiber design, in accordance with one or more embodiments of the present disclosure.

FIG. 3B is a cross-sectional view of a nested anti-resonant hollow-core fiber design, in accordance with one or more embodiments of the present disclosure.

FIG. 3C is a cross-sectional view of an anti-resonant hollow-core fiber design with split cylinders, in accordance with one or more embodiments of the present disclosure.

FIG. 3D is a cross-sectional view of a conjoined anti-resonant hollow-core fiber design, in accordance with one or more embodiments of the present disclosure.

FIG. 3E is a cross-sectional view of a nested anti-resonant hollow-core fiber design, in accordance with one or more embodiments of the present disclosure.

FIG. 3F is a cross-sectional view of a nested anti-resonant hollow-core fiber design, in accordance with one or more embodiments of the present disclosure.

FIG. 3G is a cross-sectional view of a nested anti-resonant hollow-core fiber design, in accordance with one or more embodiments of the present disclosure.

FIG. 3H is a cross-sectional view of a nested anti-resonant hollow-core fiber design, in accordance with one or more embodiments of the present disclosure.

FIG. 4 is a flow diagram illustrating steps performed in a method for drawing a fiber, in accordance with one or more embodiments of the present disclosure.

### DETAILED DESCRIPTION

Reference will now be made in detail to the subject matter disclosed, which is illustrated in the accompanying drawings. The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure.

Embodiments of the present disclosure are directed to systems and methods for fabricating an optical fiber using a multi-stage single-draw process. As used herein, a draw process refers to a single operation of a draw tower to pull material from a preform into a new form with a smaller diameter than the preform. The resulting material may be in the form of an optical fiber (referred to herein simply as fiber) or simply as material with a smaller diameter as the preform (e.g., a cane, an intermediate preform, or the like). Further, the resulting material at the end of a draw process is fully cooled and may be removed from the draw tower as a final product or for further processing. A multi-draw process may then refer to multiple sequential operations of a draw tower (or sequential operations of multiple draw towers) to progressively reduce a diameter of a preform. The term stage is used herein to describe a process of drawing a material from a certain diameter to a smaller diameter through heating and pulling. A draw process as contemplated herein may thus have one or more stages. For example, a single-stage single-draw process may correspond to a single operation of a draw tower to reduce the diameter of a preform from an initial diameter to a final diameter with a single draw furnace, while a multi-stage single-draw process may correspond to a single operation of a draw tower to progressively reduce the diameter of a preform from an initial diameter to a final diameter with multiple draw furnaces.

In embodiments, a multi-stage fiber fabrication system includes multiple draw furnaces and/or pullers, each associated with a different stage, to progressively scale down a diameter of a preform into an optical fiber in a single draw. The use of multiple stages in a single-draw process may enable precise control over various parameters of the preform at each stage including, but not limited to, a draw-down ratio (e.g., a ratio of the diameter of the fiber before and after a particular stage), tension, draw speed, cross-section, and/or temperature. A multi-stage fiber fabrication system may further include sensors to monitor a preform at any number of the stages, which may be used to generate control signals for any component of the system at any stage. It is contemplated herein that the systems and methods disclosed herein may be particularly suitable for, but not limited to, hollow core fibers (HCFs). The terms hollow-core optical fiber, hollow-core fiber, and antiresonant hollow-core fiber are used interchangeably herein.

A typical process for manufacturing an optical fiber may include first generating a preform having a diameter many times the desired fiber diameter and then scaling down a diameter of the preform using a draw process to form an optical fiber with desired dimensions. For a solid-core fiber, the preform may generally be formed as a cylindrical rod with a diameter that is many times the desired fiber diameter. For an HCF, the preform may generally be fabricated to provide a desired cross-section at the end of the drawing process. In either case, a draw tower may also include additional components to anneal, cool, coat, cure, and/or wind the fiber as it is drawn.

In many applications, an optical fiber is generated using a single draw process with a single draw-down stage. For example, a single-stage draw tower may have a single draw furnace (e.g., a single stage) and is designed to directly generate an optical fiber with a desired diameter from a preform. Such a single-stage single-draw process may generally be used to fabricate solid-core fibers or HCFs. However, as is described in greater detail throughout the present disclosure, such a technique may have limitations on the length of fiber that may be produced, particularly when fabricating an HCF.

The length of fiber generated in a single draw may depend on the diameter and/or length of the preform and thus the amount of material in the preform. The overall dimensions of the preform may differ based on the process type, the type of fiber to be produced, and/or limitations of the draw tower, though it is typically desirable to provide relatively large diameters to increase fiber production (e.g., length of a finished fiber). As an illustration, silica-based fibers for telecom applications are commonly fabricated with a preform having diameters on the order of several centimeters up to about 20 cm and lengths on the order of tens of centimeters up to meters, which may allow for the fabrication of thousands of kilometers of fiber in a single draw.

However, it is contemplated herein that HCFs present various challenges that may limit high-volume manufacturing (e.g., fabrication of HCFs with long lengths) when using a single-stage single-draw process. For example, HCF preforms may be susceptible to collapse, inflation, and/or structural geometry changes (e.g., degradation) during the drawing process. Further, HCFs may require relatively high precision when controlling various aspects of the drawing process such as, but not limited to, tension, temperature, or pressure in any capillaries used to form hollow regions. As a result, there are practical limits on the size of the preform (e.g., the diameter of the preform) that may be used to fabricate HCFs with a single-stage single-draw process.

Embodiments of the present disclosure are directed to fabricating HCFs using a multi-stage single-draw process, where each stage has a separate draw furnace to reduce a diameter of the preform. Such a configuration enables a gradual draw-down process and commensurate control over the draw-down process for each stage. For example, the draw-down ratio at each stage (e.g., a ratio of fiber diameter before and after each stage) may be maintained at levels that may promote high quality fibers and mitigate collapse, over-inflation, and/or structural degradation that may be detrimental to performance of the fully-fabricated HCF. Further, the use of multiple draw stages as disclosed herein may allow the use of relatively large-diameter preforms (e.g., up to or greater than 10 mm) for the fabrication of relatively long fiber lengths (e.g., tens or hundreds of kilometers) in a single draw. Put another way, the use of multiple draw stages as disclosed herein may allow the use of preforms with larger diameters than a single-stage single-draw process would tolerate.

Any of the stages may further include additional components to control the draw-down process at each stage such as, but not limited to, dedicated pullers. Additionally, the system may include monitoring equipment to monitor properties of the preform and/or fiber at any of the stages such as, but not limited to, fiber geometry monitors, diameter monitors, temperature monitors, or tension monitors. Further, monitoring equipment may monitor the operational parameters of any of the equipment including, but not limited to, draw furnaces, pullers, spools, or the like. Data from such monitoring equipment may then be used for feedback and/or feed-forward control for the associated stage and/or the process as a whole. In this way, parameters of the fiber such as, but not limited to, the tension, diameter, fiber geometry, and temperature (e.g., based on draw rate, draw-down ratio, or the like) may be independently controlled.

It is further contemplated herein that the systems and methods disclosed herein may provide numerous advantages over alternative techniques for fabricating HCFs and may enable HCF manufacturing at scales unreachable or difficult to achieve using current techniques.

For example, existing single-stage single-draw HCF fabrication techniques are limited to preform sizes on the order of a few centimeters (e.g., 1-3 cm) in diameter to maintain an acceptable draw-down ratio and avoid collapse, over-inflation, and/or structural deformation during the drawing process. As another example, existing single-stage multi-draw techniques allow for some improvements to the achievable fiber length, but suffer from high complexity and/or low throughput. In a single-stage multi-draw technique, a preform is first drawn using a traditional single-stage draw process into one or more intermediate preforms having an intermediate diameter smaller than the preform but larger than a final diameter (e.g., on the order of a few millimeters to a few centimeters), which are often referred to as canes. These intermediate preforms (e.g., canes) may generally have any length, but are approximately 1-5 meters in some cases. The intermediate preform may then be subsequently drawn using a second traditional single-stage draw process to form a final fiber. In some cases, the intermediate preforms are modified (e.g., inserted into additional tubes of material to increase an outer cladding thickness) prior to the second draw. However, the length of the final fiber may be limited by the diameter and/or length of each intermediate preform. In some cases, the length of the final fiber using such a single-stage multi-draw technique may be limited to a few kilometers. Further, such a technique is time consuming and requires separate configuration of the draw tower for each draw or multiple towers for the multiple draws.

In contrast, the systems and methods disclosed herein may be suitable for efficient manufacturing HCFs with lengths of tens or hundreds of kilometers in a single draw based on preforms having relatively large diameters (e.g., up to 10 cm or greater). This is accomplished at least in part by the use of multiple draw stages to gradually step down the diameter of the fiber through one or more intermediate diameters before reaching the desired diameter in a single draw.

It is further contemplated herein that the systems and methods disclosed herein may be suitable for any HCF fiber design and/or any material composition. Further, the precise and gradual draw down provided by the systems and methods disclosed herein may enable the fabrication of more complex fiber designs (e.g., those more prone to collapse, over-inflation, or structural degradation) that may be difficult or impossible to obtain with existing techniques.

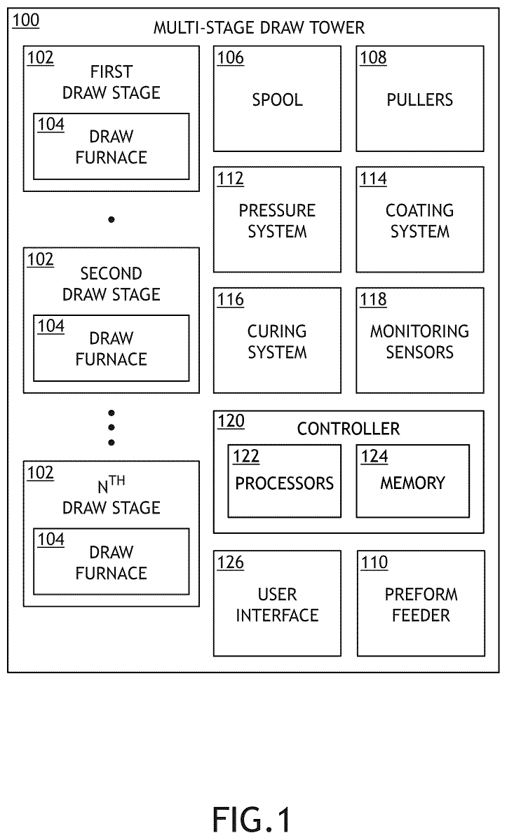

Referring now to FIGS. 1-4, systems and methods for fabrication of HCFs are described in greater detail, in accordance with one or more embodiments of the present disclosure.

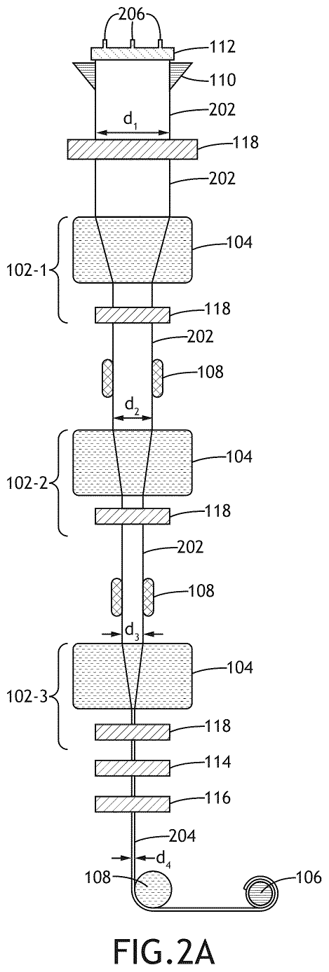

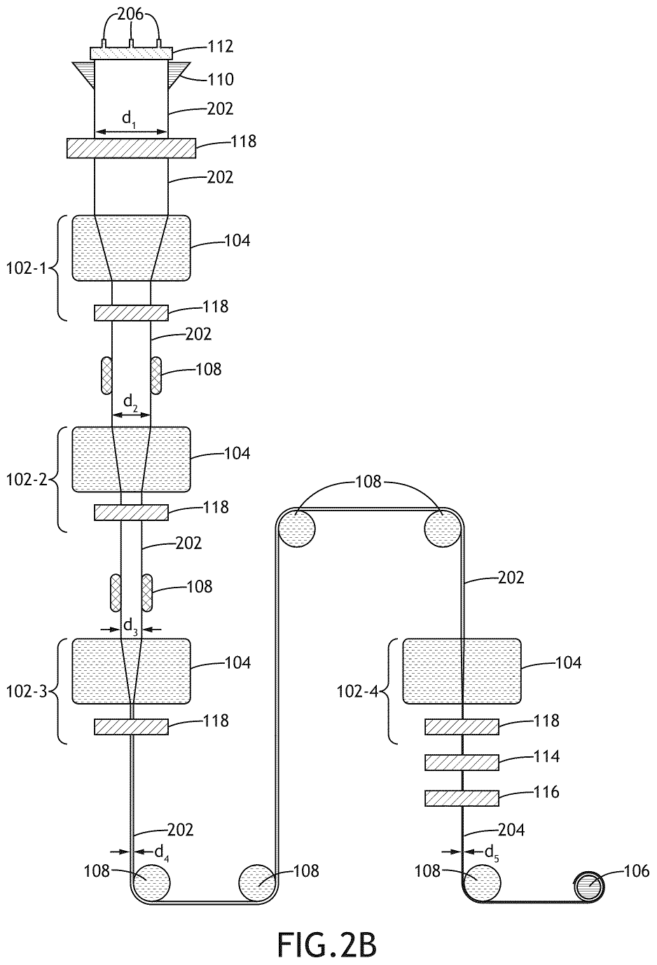

FIG. 1 is a block diagram of a multi-stage draw tower 100, in accordance with one or more embodiments of the present disclosure. FIG. 2A is a simplified schematic of a multi-stage draw tower 100 including three draw stages 102, in accordance with one or more embodiments of the present disclosure. The draw stages 102 are individually marked in FIG. 2A with numerals 102-1, 102-2, and 102-3.

In some embodiments, the multi-stage draw tower 100 includes two or more draw stages 102, where each draw stage 102 includes at least a dedicated draw furnace 104 to reduce a diameter of a preform 202 by a selected draw ratio. In this way, the draw stages 102 may progressively draw down the preform 202 into a fiber 204 (e.g., an HCF) with a desired diameter. The multi-stage draw tower 100 may further include one or more spools 106 to collect and/or store the fiber 204 as it is drawn.

For the purposes of the present disclosure, the term preform 202 is generally used to refer to material placed into the multi-stage draw tower 100 that is progressively drawn through one or more intermediate diameters. The term fiber 204 is generally used to refer to the material at a final diameter and is typically suitable for guiding light at one or more selected wavelengths. However, it is to be understood that the terms preform 202 and fiber 204 are used herein merely for illustration to describe the evolution of material through a draw process and should not be interpreted as imposing limitations on any property of the associated material including, but not limited to, structural, chemical, and/or optical properties. In this way, references to a preform 202 or a fiber 204 at any stage of a draw process is merely illustrative and should not be interpreted as limiting. Unless explicitly noted, any references to a preform 202 herein may be extended to a fiber 204 and vice versa. In particular, references to monitoring one or more characteristics of a preform 202 throughout any of the draw stages 102 may be extended to monitoring one or more characteristics of the fiber 204 after a final draw stage 102 and vice versa.

As an illustration, FIG. 2A depicts a preform 202 with a first diameter d1 in a preform feeder 110 and entering a first draw stage 102-1, a second diameter d2 exiting the first draw stage 102-1 and entering a second draw stage 102-2, a third diameter d3 exiting the second draw stage 102-2 and entering a third draw stage 102-3. FIG. 2A then depicts a fiber 204 with a fourth diameter d4 exiting the third draw stage 102-3. In this way, it is readily apparent that specific reference to the material being drawn through the multi-stage draw tower 100 as a preform 202 or fiber 204 is merely convention and not limiting on the disclosure.

The multi-stage draw tower 100 disclosed herein may be suitable for fabricating any design of fiber 204 including, but not limited to, solid-core fiber or HCF. It is contemplated herein that a multi-stage draw tower 100 may be particularly beneficial for fabricating HCFs including, but not limited to, anti-resonant HCFs in which light is guided in a hollow core as a result of anti-resonant properties of thin walled structures extending along a length of the fiber 204.

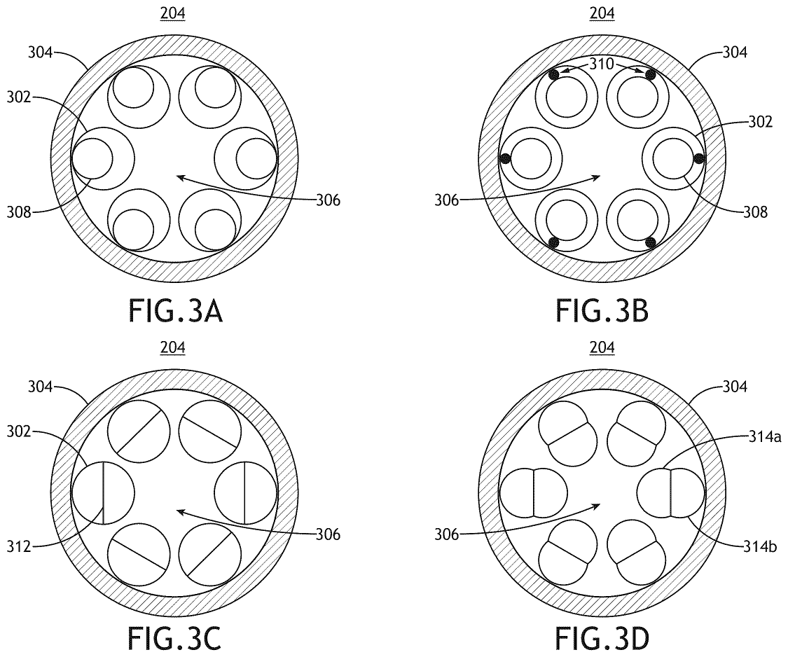

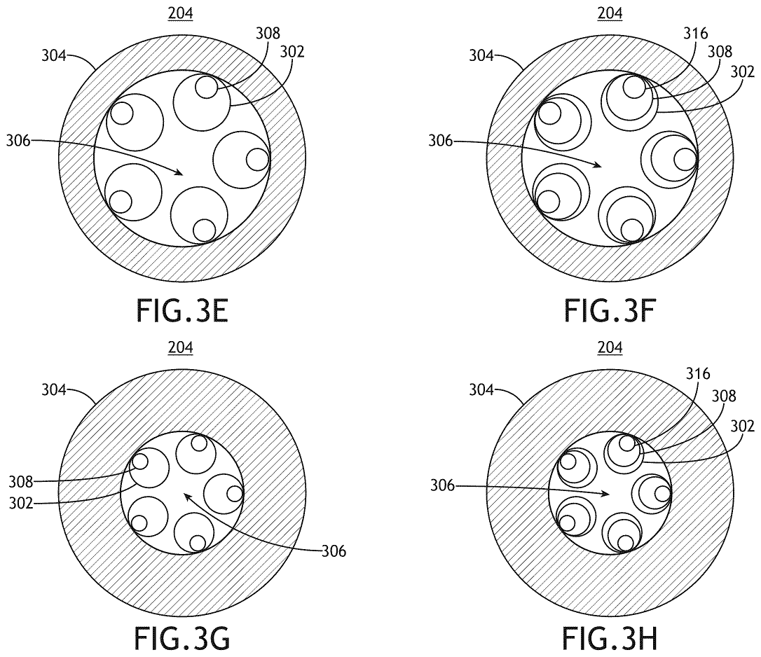

Referring now to FIGS. 3A-3H, various non-limiting examples of fibers 204 that may be manufactured with the multi-stage draw tower 100 are depicted. In particular, FIGS. 3A-3D depict various anti-resonant HCF designs. Anti-resonant HCF designs are generally described in Md. Selim Habib, et al., “Single-mode, low loss hollow-core anti-resonant fiber designs,” Opt. Express 27, 3824-3836 (2019), which is incorporated herein by reference in its entirety. For example, an anti-resonant HCF may include walled features (e.g., cylinders, tubes, membranes, or the like) within an interior cavity of a cladding, where the walled features guide light of one or more selected wavelengths within a hollow central region of the interior cavity based on optical anti-resonance.

FIG. 3A is a cross-sectional view of a nested anti-resonant hollow-core fiber 204 design, in accordance with one or more embodiments of the present disclosure. The design in FIG. 3A includes multiple (e.g., six) hollow cylinders 302 (e.g., walled structures) distributed around an outer cylinder 304 (e.g., a cladding) to form a central opening 306 (e.g., the hollow central region in which light is guided by optical anti-resonance), where each of the cylinders 302 include a nested cylinder 308.

FIG. 3B is a cross-sectional view of a nested anti-resonant hollow-core fiber 204 design, in accordance with one or more embodiments of the present disclosure. The design in FIG. 3B includes rods 310 between the cylinders 302 and the cylinders 308 to provide that that the cylinders 308 are centered within the cylinders 302.

FIG. 3C is a cross-sectional view of an anti-resonant hollow-core fiber 204 design with split cylinders 302, in accordance with one or more embodiments of the present disclosure. The design in FIG. 3C includes membranes 312 (e.g., bars, additional walls, or the like) dividing the cylinders 302 into two cavities with any size ratio.

FIG. 3D is a cross-sectional view of a conjoined anti-resonant hollow-core fiber 204 design, in accordance with one or more embodiments of the present disclosure. The design in FIG. 3D includes pairs of conjoined cylinders 314a,b surrounding the central opening 306.

It is to be understood that FIGS. 3A-3D are merely illustrative and should not be interpreted as limiting the designs of a hollow-core fiber 204 that may be fabricated with a multi-stage draw tower 100 as disclosed herein. As an illustration, FIGS. 3D-3H depict variations of the design of FIG. 3A, in accordance with one or more embodiments of the present disclosure.

FIG. 3E is a cross-sectional view of a nested anti-resonant hollow-core fiber 204 design, in accordance with one or more embodiments of the present disclosure. FIG. 3E is substantially similar to FIG. 3A except that it includes five rather than six sets of nested cylinders 302, 308. A hollow-core fiber 204 may include any number of sets of nested elements such as, but not limited to, three, four, five, six, or more sets.

FIG. 3F is a cross-sectional view of a nested anti-resonant hollow-core fiber 204 design, in accordance with one or more embodiments of the present disclosure. FIG. 3F is substantially similar to FIG. 3E except that each set of nested elements includes three cylinders (e.g., cylinders 302, cylinders 308, and cylinders 316). A hollow-core fiber 204 may include any number of features within any set of nested elements. Further, a hollow-core fiber 204 may include sets of nested elements with varying designs.

FIGS. 3G and 3H depict variations of FIGS. 3E and 3F with larger thicknesses of the outer cylinder 304 (e.g., cladding). FIG. 3G is a cross-sectional view of a nested anti-resonant hollow-core fiber 204 design, in accordance with one or more embodiments of the present disclosure. FIG. 3G is substantially similar to FIG. 3E except that it includes a thicker outer cylinder 304. FIG. 3H is a cross-sectional view of a nested anti-resonant hollow-core fiber 204 design, in accordance with one or more embodiments of the present disclosure. FIG. 3H is substantially similar to FIG. 3F except that it includes a thicker outer cylinder 304. A hollow-core fiber 204 may have any thickness and may further include any number of additional structures.

In FIGS. 3A-3H, anti-resonant properties of the walls of any of the features (e.g., cylinders 302, cylinders 308, bars 312, cylinders 314, cylinders 316, or the like) may provide guiding of light in the central opening 306. Further, the fibers 204 depicted in FIGS. 3A-3H may be fabricated based on preforms having any design or dimensions suitable that produce the associated design after the draw process. For example, the associated preforms may have the same designs as the depicted fibers 204, but with scaled dimensions. As another example, some features of the associated preforms may have different designs than the corresponding structures in the final fibers 204 to compensate for known or expected deviations induced by the draw process. As an illustration, a relative diameter or thickness of any of the cylinders (e.g., cylinders 302, cylinders 308, cylinders 314, cylinders 316, or the like) in a preform 202 may be larger or smaller than desired in a final fiber 204 to compensate for known or expected shrinkage or inflation during the draw process.

The multi-stage draw tower 100 disclosed herein may further be suitable for fabricating a fiber 204 having any composition. For example, any components (e.g., cylinders 302, cylinder 304, cylinders 308, cylinders 314, cylinders 316, membranes 312 or the like as depicted in the non-limiting designs in FIGS. 3A-3H) may be formed silica glass, doped silica glass, chalcogenide glass, fluoride glass, or the like. Further, any such components may be undoped or doped with one or more dopants. Additionally, a fiber 204 may be formed from a single material or may have different components formed from different materials. For example, an outer cylinder 304 (e.g., a cladding) may be formed from a different material than any of the internal components (e.g., cylinders 304, cylinders 308, cylinders 314, cylinders 316, membranes 312, or the like). As another example, any of the internal components may be formed from different materials than other internal components.

Additionally, it is contemplated herein that the multi-stage draw tower 100 may be suitable for manufacturing any type of fiber 204 including, but not limited to, solid-core fibers, photonic crystal fibers, or anti-resonant HCFs. Accordingly, the illustrations in FIGS. 3A-3H are intended to be illustrative of some of the capabilities of the multi-stage draw tower 100, but do not limit the multi-stage draw tower 100.

Referring generally to FIGS. 1-2B, additional aspects of the multi-stage draw tower 100 are described, in accordance with one or more embodiments of the present disclosure.

In some embodiments, the multi-stage draw tower 100 includes one or more pullers 108 to control a draw rate and/or a tension of the preform 202 (or fiber 204) throughout the drawing process. It is contemplated herein that the draw rate associated with any particular draw stage 102 (e.g., a current draw stage 102) may be selected based on considerations such as, but not limited to, a draw rate provided by a previous draw stage 102 (or the preform feeder 110 in the case of the first draw stage 102), a temperature of preform 202 entering the current draw stage 102, a tension on the preform 202 entering the current draw stage 102, a temperature of the draw furnace 104 of the current draw stage 102, or a desired draw-down ratio. Further, the draw rate from one draw stage 102 becomes a feed rate into a subsequent draw stage 102.

The one or more pullers 108 may include any component or combination of components suitable for controlling a draw rate of the preform 202 (or fiber 204) at any draw stage 102 and may include, but is not limited to, one or more belts or one or more wheels. A puller 108 may generally include components integrated into one or more draw stages 102 and/or components outside of any of the draw stages 102. For example, any draw stage 102 may have a dedicated puller 108 or components thereof to separately control the draw rate at that draw stage 102. As another example, the multi-stage draw tower 100 may have one or more pullers 108 that may impact the draw rate of the preform 202 (or fiber 204) through the multi-stage draw tower 100 as a whole. FIG. 2A illustrates a non-limiting configuration including pullers 108 as part of first and second draw stages 102 as well as a puller 108 (e.g., a capstan) after all of the draw stages 102 and prior to a spool 106. However, this depiction is merely illustrative and not limiting.

A multi-stage draw tower 100 may generally have any number of draw stages 102. For example, the multi-stage draw tower 100 may have two, three, four, or more draw stages 102. FIG. 1 depicts a series of N draw stages 102, each with a dedicated draw furnace 104. FIG. 2A depicts a multi-stage draw tower 100 including three draw stages 102-1 through 102-3, configured to progressively reduce a diameter of a preform 202 of material placed at a top of the multi-stage draw tower 100 from an initial diameter d1 to a fiber 204 with a final diameter d4 in a single draw.

In some embodiments, the draw furnaces 104 of the various draw stages 102 are arranged vertically such that the preform 202 may be drawn in a downward direction. However, this is not a requirement. FIG. 2B is a simplified schematic of a multi-stage draw tower 100 including four draw stages 102 to reach a final diameter d₅ of the fiber 204, where the draw stages 102 are not vertically aligned, in accordance with one or more embodiments of the present disclosure. FIG. 2B is substantially similar to FIG. 2A except for the arrangement of the draw stages 102. In particular, FIG. 2B depicts a configuration in which a fourth draw stage 102-4 is laterally offset from the third draw stage 102-3. In this configuration, the multi-stage draw tower 100 includes additional pullers 108 to direct the preform 202 to the fourth draw stage 102-4. Notably, such a configuration may require that the preform 202 have a sufficiently small diameter between the third draw stage 102-3 and the fourth draw stage 102-4 to allow for manipulation without breakage. As another example, though not shown, various additional components such as, but not limited to monitoring sensors 118, a coating system 114, or a curing system 116 may be horizontally offset and/or arranged horizontally. In this configuration, the multi-stage draw tower 100 may include pullers 108 to manipulate the fiber 204 accordingly. Any of these configurations may reduce an overall height of the multi-stage draw tower 100 and an associated building or other structure surrounding it.

It is contemplated herein that different applications may benefit from a different number of draw stages 102.

For instance, increasing the number of draw stages 102 may decrease the draw-down ratio required for each draw stage 102 to reach a desired diameter of the fiber 204. As a non-limiting illustration, a multi-stage draw tower 100 with two draw stages 102 may draw down a 10 cm preform 202 to an intermediate diameter of 3 cm using a first draw stage 102 and then to a final 300 micrometer (micron) diameter using a second draw stage 102. As another non-limiting illustration, a multi-stage draw tower 100 with three draw stages 102 may draw down a 10 cm preform 202 to a first intermediate diameter of 5 cm using a first draw stage 102, a second intermediate diameter of 1 cm using a second draw stage 102, and then to a final 300 micrometer diameter using a third draw stage 102. As another non-limiting illustration, a multi-stage draw tower 100 with three draw stages 102 may draw down a 10 cm preform 202 to a first intermediate diameter of 5 cm using a first draw stage 102, a second intermediate diameter of 1 cm using a second draw stage 102, and then to a final 125 micrometer diameter using a third draw stage 102. Put another way, increasing a number of draw stages 102 may enable increasing a diameter and/or length of the preform 202 and thus increasing a total length of fiber 204 that may be produced in a single draw by maintaining acceptable draw-down ratios at each draw stage 102. However, increasing the number of draw stages 102 may also increase the overall height of the multi-stage draw tower 100 (which may impact required building space), cost, and complexity. Accordingly, the number of draw stages 102 in a given embodiment may be selected based on the requirements and goals of a particular application.

The draw furnace 104 in any draw stage 102 may include any components or combinations of components suitable for heating a preform 202 and/or fiber 204 of any diameter. For example, a draw furnace 104 may include one or more heating elements (e.g., radiative heating elements, conductive heat elements, inductive heating elements, or the like) to heat the preform 202 at any draw stage 102. In this way, a draw furnace 104 may control a temperature of the preform 202 to facilitate drawing at a desired draw rate and/or provide a desired draw ratio.

In some embodiments, the multi-stage draw tower 100 includes a preform feeder 110 to feed the preform 202 into the first draw furnace 104. For example, the preform feeder 110 may include components to secure the preform 202 such as, but not limited to, holders, clips, springs, or the like. As another example, the preform feeder 110 may include components to position the preform 202 and/or lower the preform 202 into the first draw furnace 104 such as, but not limited to, one or more translation stages. Such components may position and/or lower the preform 202 at a constant speed, a variable speed, or a dynamically-controlled speed (e.g., based on feedback from monitoring sensors 118 as described herein).

The draw furnaces 104 in different draw stages 102 may have the same or different configurations or operational parameters. For example, draw furnaces 104 in different draw stages 102 may heat the preform 202 and/or fiber 204 to different temperatures, which may allow tailored control at each draw stage 102. Further, different draw furnaces 104 in different draw stages 102 may have different sizes and/or supporting structures based on the expected diameter of the fiber 204 at each draw stage 102. Additionally, different draw furnaces 104 may have different sizes and/or heat zone profiles (e.g., distributions of heating temperature along a pulling direction).

Additionally, although not shown, the multi-stage draw tower 100 may include one or more additional furnaces to provide additional processing functions besides drawing down the preform 202 diameter. For example, additional furnaces may be used to anneal the preform 202 at any draw stage 102 and/or the fiber 204 once it reaches the desired diameter.

In some embodiments, the multi-stage draw tower 100 includes a pressure system 112 to apply a pressure to the preform 202 (e.g., at the preform feeder 110).

The pressure system 112 may include any components or combination of components suitable for applying pressure (or a differential pressure) to the preform 202 and/or the fiber 204 at any draw stage 102 and may include, but is not limited to, pressure manifolds or components providing active pressure control. As an illustration, FIGS. 2A and 2B depict a pressure system 112 with multiple pressure manifolds 206 to apply different pressures to different parts of the fiber 204 and/or preform 202. As an illustration in the case of a hollow-core fiber 204 with a design shown in FIG. 3F, the pressure system 112 may include pressure manifolds 206 to individually control the pressure of different hollow regions such as, but not limited to, within the cylinders 316, between the cylinders 308 and the cylinders 316, between the cylinders 302 and the cylinders 308, or within the central cavity 306. In some embodiments, however, a constant pressure may be applied to all portions of the fiber 204.

The pressure system 112 may generally apply a positive pressure to any region, a negative pressure (e.g., a vacuum) to any region, or control a differential pressure between any regions. Further, the pressure system 112 may control a composition of a gas within any hollow regions of the fiber 204. In some embodiments, the pressure system 112 fills one or more hollow regions with a gas of a selected composition such as, but not limited to, nitrogen, argon, or any inert gas. In some embodiments, the pressure system fills one or more hollow regions with ambient atmosphere (or allows the hollow regions to be filled with ambient atmosphere).

In some embodiments, the multi-stage draw tower 100 includes a coating system 114 to coat the fiber 204 after it has reached a desired diameter. The coating system 114 may include any component or combination of components suitable for coating the fiber 204. For example, coating system 114 may include one or more containers with a coating fluid (e.g., a polymer, an acrylate, or any suitable compound) through which the fiber 204 may pass such that the coating fluid surrounds the fiber 204. The coating system 114 may provide multiple coats of the same or different materials.

In some embodiments, the multi-stage draw tower 100 includes a curing system 116 to cure one or more coatings on the fiber 204. The curing system 116 may include any component or combination of components suitable for curing the fiber 204 and/or one or more coatings on the fiber 204. For example, the curing system 116 may include, but is not limited to, one or more light sources or one or more heat sources. As an illustration, the curing system 116 may include one or more ultraviolet (UV) light sources or one or more curing ovens.

In some embodiments, the multi-stage draw tower 100 includes one or more monitoring sensors 118 to monitor one or more aspects of the preform 202, the fiber 204, any of the draw stages 102, and/or the multi-stage draw tower 100 as a whole. The monitoring sensors 118 may include any component or combination of components suitable for monitoring the preform 202, the fiber 204, any of the draw stages 102, and/or the multi-stage draw tower 100 as a whole such as, but not limited to, one or more sensors. Further, the monitoring sensors 118 (or components thereof) may be distributed throughout the multi-stage draw tower 100 in any manner and may optionally be integrated into any of the draw stages 102.

As an example, the monitoring sensors 118 may include one or more diameter sensors to monitor the diameter of the preform 202 (or fiber 204) at any point. As another example, the monitoring sensors 118 may include one or more speed sensors to monitor the draw speed of the preform 202 (or fiber 204) at any point. As another example, the monitoring sensors 118 may include one or more temperature sensors to monitor the temperature of the preform 202 (or fiber 204) at any point. As another example, the monitoring sensors 118 may include one or more tension sensors to monitor the tension of the preform 202 (or fiber 204) at any point. As another example, the monitoring sensors 118 may include one or more sensors to monitor an internal geometry of the preform 202 (or fiber 204) at any point. As another example, the monitoring sensors 118 may include one or more sensors to monitor pressure applied to the preform 202 and/or relative pressures applied to various portions of the preform 202 by the pressure system 112. As another example, the monitoring sensors 118 may include one or more sensors to monitor coating application pressure, temperature and/or diameter of the one or more coatings on the fiber 204.

As another example, the monitoring sensors 118 may include one or more sensors to monitor any components of the multi-stage draw tower 100 such as, but not limited to, the draw furnaces 104, the one or more pullers 108, the pressure system 112, the coating system 114, or the curing system 116. In this way, the efficiency and/or operational status of the components of the multi-stage draw tower 100 may be monitored and acted upon as appropriate. As an illustration, the monitoring sensors 118 may include various sensors at each draw stage 102 (or at least some of the draw stages 102) to monitor the any selected properties of the preform 202 and/or the fiber 204 such as, but not limited to, diameter, internal geometry, draw speed, temperature, tension, or any other suitable property.

In embodiments, the multi-stage draw tower 100 includes a controller 120 communicatively coupled to any components therein. In some embodiments, the controller 120 includes one or more processors 122 configured to execute a set of program instructions maintained in a memory 124, or memory device. The one or more processors 122 of the controller 120 may include any processing element known in the art. In this sense, the one or more processors 122 may include any microprocessor-type device configured to execute algorithms and/or instructions. For the purposes of the present disclosure, the term “processor” or “processing element” may be broadly defined to encompass any device having one or more processing or logic elements (e.g., one or more micro-processor devices, one or more application specific integrated circuit (ASIC) devices, one or more field programmable gate arrays (FPGAs), or one or more digital signal processors (DSPs)).

In some embodiments, the one or more processors 122 are formed as or integrated within a desktop computer, mainframe computer system, workstation, image computer, parallel processor, networked computer, or any other computer system configured to execute program instructions. Further, the steps described throughout the present disclosure may be carried out by a single controller or, alternatively, multiple controllers. Additionally, the controller 120 may include one or more controllers housed in a common housing or within multiple housings.

The memory 124 may include any storage medium known in the art suitable for storing program instructions executable by the associated one or more processors 122. For example, the memory 124 may include a non-transitory memory medium. By way of another example, the memory 124 may include, but is not limited to, a read-only memory (ROM), a random-access memory (RAM), a magnetic or optical memory device (e.g., disk), a magnetic tape, a solid-state drive and the like. It is further noted that the memory 124 may be housed in a common controller housing with the one or more processors 122. In some embodiments, the memory 124 may be located remotely with respect to the physical location of the one or more processors 122 and the controller 120. For instance, the one or more processors 122 of the controller 120 may access a remote memory (e.g., server), accessible through a network (e.g., internet, intranet and the like).

In embodiments, the multi-stage draw tower 100 includes a user interface 126 communicatively coupled to the controller 120. In one embodiment, the user interface 126 may include, but is not limited to, one or more desktops, laptops, tablets, and the like. In another embodiment, the user interface 126 includes a display used to display data to a user. The display of the user interface 126 may include any display known in the art. For example, the display may include, but is not limited to, a liquid crystal display (LCD), an organic light-emitting diode (OLED) based display, or a CRT display. Those skilled in the art should recognize that any display device capable of integration with a user interface 126 is suitable for implementation in the present disclosure. In another embodiment, a user may input selections and/or instructions responsive to data displayed to the user via a user input device of the user interface 126.

The controller 120 may be communicatively coupled with any components of the multi-stage draw tower 100 such as, but not limited to, the preform feeder 110, the pressure system 112, the draw furnaces 104, the pullers 108, the coating system 114, the curing system 116, the monitoring sensors 118, or the user interface 126. In this way, the controller 120 may direct the operation of any such components (e.g., via control signals) and/or receive data from any such components. As an example, the controller 120 may initialize and/or direct the operation of any of the components with parameters suitable for drawing a particular fiber 204 based on parameters such as, but not limited to, the design, composition, or size of preform 202. As another example, the controller 120 may receive monitoring data from the monitoring sensors 118 (e.g., associated with the preform feeder 110, the pressure system 112, any of the draw stages 102, any of the pullers 108, the or the drawing process as a whole). In this way, the monitoring data may be used for feedback and/or feed-forward control of the drawing process. As an illustration, the controller 120 may adjust any operating parameters of any of the components of the multi-stage draw tower 100 to ensure that a current fiber 204 is manufactured within tolerances for the length of the fiber 204 using feedback control techniques. As another illustration, the controller 120 may adjust any operating parameters of any of the draw stages 102 and/or components to ensure that a future fiber 204 of a similar design is manufactured within tolerances based on data obtained from one or more previously fabricated fibers 204.

In some embodiments, the controller 120 implements (e.g., via the processors 122) any number or type of control loops through feed-forward and/or feedback based on data from one or more monitoring sensors 118. In particular, the controller 120 may generate control signals to adjust any components of the multi-stage draw tower 100. For example, the controller 120 may receive data from monitoring sensors 118 associated with a diameter of the preform 202 at one draw stage 102 (e.g., the second draw stage 102-2) and dynamically adjust a puller 108 after the previous draw stage 102 (e.g., the first draw stage 102-1) to control the feed rate. More generally, since the draw rate at one draw stage 102 is the feed rate at a subsequent draw stage 102, the controller 120 may dynamically control the draw rates/feed rates across all stages to maintain desired draw ratios and/or diameters at each draw stage 102. As another example, the controller 120 may receive diameter and/or geometry measurements from monitoring sensors 118 and dynamically adjust the pressure system 112 to adjust pressures applied to any of the regions of the preform 202. In this way, the controller 120 may maintain a desired diameter and/or geometry profile and thus mitigate collapse, over-inflation, structural degradation, or the like.

Referring now generally to FIGS. 1-2B, it is contemplated herein that a multi-stage draw tower 100 may be operated in different modes. In this way, a particular design or embodiment of the multi-stage draw tower 100 may be flexibly utilized to fabricate a wide range of fibers 204.

In some embodiments, one or more draw stages 102 may be selectively operated or left dormant during a given draw. For example, it may be the case that not all applications or compositions may require or benefit from all available draw stages 102 of a particular embodiment of the multi-stage draw tower 100. In such cases, one or more of the draw stages 102 or portions thereof may be selectively dormant during a draw. In this way, a multi-stage draw tower 100 with three draw stages 102 may operate only two draw stages 102 (or even a single draw stage 102) for a given draw. In this way, the multi-stage draw tower 100 may be configurable for a wide range of solid-core and/or hollow-core designs or applications.

In some embodiments, the monitoring sensors 118 includes one or more actuators and/or translation stages to adjust the absolute or relative locations of any of the components. For example, relative spacings between any of the draw stages 102 may be adjusted to provide additional control over parameters of the fiber 204 including, but not limited to, the diameter, temperature, or tension.

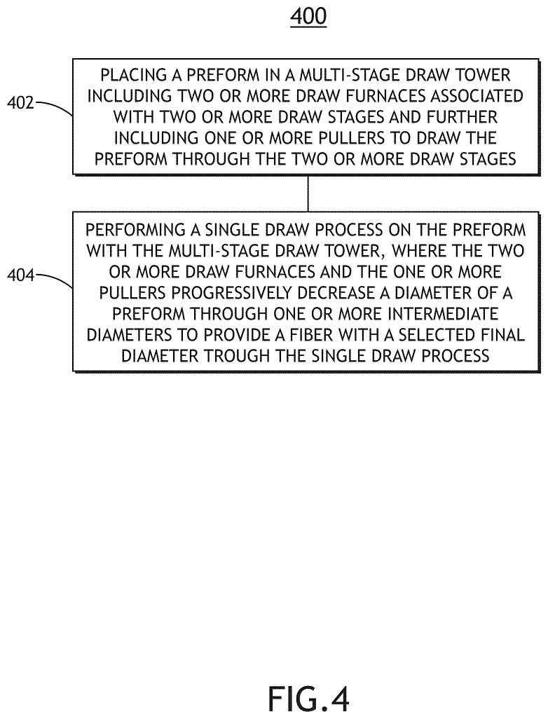

FIG. 4 is a flow diagram illustrating steps performed in a method 400 for drawing a fiber 204, in accordance with one or more embodiments of the present disclosure. Applicant notes that the embodiments and enabling technologies described previously herein in the context of the multi-stage draw tower 100 should be interpreted to extend to the method 400. It is further noted, however, that the method 400 is not limited to the architecture of the multi-stage draw tower 100.

In some embodiments, the method 400 includes a step 402 of placing a preform 202 in a multi-stage draw tower (e.g., the multi-stage draw tower 100).

In some embodiments, the method 400 includes a step 404 of performing a single draw process on the preform 202 with the multi-stage draw tower 100, where two or more draw furnaces 104 and/or one or more pullers 108 of the multi-stage draw tower 100 progressively decrease a diameter of the preform 202 through one or more intermediate diameters to provide a fiber 204 with a selected final diameter through the single draw process.

It is contemplated herein that the method 400 may be suitable for drawing relatively long lengths of the fiber 204 in a single draw by successively decreasing the diameter of the preform 202 with the two or more draw stages 102. For example, the preform 202 may have any suitable diameter including, but not limited to, diameters of 2 cm, 3 cm, 5 cm, 10 cm, 15 cm, or greater, which may provide fiber lengths on the order of up to tens, hundreds, or potentially thousands of kilometers. It is further contemplated herein that such fiber lengths may be achieved using any design of the fiber 204 including, but not limited to, HCFs. For example, HCFs in particular may be susceptible to collapse, over-inflation, and/or deformation if a draw ratio at any given draw stage is too high. However, the use of multiple draw stages 102 to successively decrease the diameter of the fiber 204 may allow the draw ratio to be maintained at a suitable level for each draw stage 102 while still allowing the use of a large diameter preform 202 for high-volume manufacturing of long fiber lengths in a single draw.

In some embodiments, the method 400 further includes generating monitoring data associated with the fiber 204 after any of the two or more draw stages 102. For example, the monitoring data may include, but is not limited to, data associated with a diameter, temperature, draw speed, or tension of the fiber 204. Such monitoring data may be used for feedback and/or feed-forward control.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected” or “coupled” to each other to achieve the desired functionality, and any two components capable of being so associated can also be viewed as being “couplable” to each other to achieve the desired functionality. Specific examples of couplable include but are not limited to physically interactable and/or physically interacting components and/or wirelessly interactable and/or wirelessly interacting components and/or logically interactable and/or logically interacting components.

It is believed that the present disclosure and many of its attendant advantages will be understood by the foregoing description, and it will be apparent that various changes may be made in the form, construction, and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

1. A multi-stage draw tower comprising:
two or more draw furnaces associated with two or more draw stages; and
one or more pullers to draw the preform through the two or more draw stages, wherein the two or more draw furnaces and the one or more pullers are configured to progressively decrease a diameter of a preform through one or more intermediate diameters to provide a fiber with a selected final diameter in a single draw process.

2. The multi-stage draw tower of claim 1, further comprising:
a pressure system configured to apply pressure to the preform prior to a first of the two or more draw stages.

3. The multi-stage draw tower of claim 2, wherein the pressure system applies different pressures to different portions of the preform.

4. The multi-stage draw tower of claim 1, further comprising:
one or more monitoring sensors configured to generate monitoring data associated with at least one of the preform or the fiber.

5. The multi-stage draw tower of claim 4, further comprising a controller including one or more processors configured to execute program instructions causing the one or more processors to:
receive the monitoring data from the one or more monitoring sensors; and
control, via control signals, at least one of the two or more draw furnaces or the one or more pullers based on the monitoring data.

6. The multi-stage draw tower of claim 5, wherein control, via control signals, at least one of the two or more draw furnaces or the one or more pullers based on the monitoring data comprises:
control, via control signals, at least one of one or more pullers based on the monitoring data to maintain a selected diameter of at least one of the preform or the fiber after a selected draw stage.

7. The multi-stage draw tower of claim 4, wherein the monitoring data comprises:
at least one of a diameter, a temperature, a draw speed, a tension, or a geometry.

8. The multi-stage draw tower of claim 7, further comprising:
a pressure system configured to apply pressure to the preform prior to a first of the two or more draw stages, wherein the monitoring data further comprises the pressure applied to the preform.

9. The multi-stage draw tower of claim 8, further comprising:
a controller including one or more processors configured to execute program instructions causing the one or more processors to:
receive the monitoring data from the monitoring system; and
control, via control signals, at least one of the two or more draw furnaces, the one or more pullers, or the pressure system based on the monitoring data.

10. The multi-stage draw tower of claim 1, further comprising:
a spool to receive the fiber from the two or more draw stages.

11. The multi-stage draw tower of claim 1, further comprising:
a coating system to coat the fiber with one or more coatings.

12. The multi-stage draw tower of claim 1, wherein the two or more draw stages comprise three or more draw stages.

13. The multi-stage draw tower of claim 1, wherein the fiber comprises:
a hollow-core fiber.

14. The multi-stage draw tower of claim 13, wherein a first draw furnace of the two or more draw furnaces is configured to accept the preform, wherein an allowable width of the preform accepted by the first draw furnace is equal to or greater than two centimeters.

15. The multi-stage draw tower of claim 13, wherein a first draw furnace of the two or more draw furnaces is configured to accept the preform, wherein an allowable width of the preform accepted by the first draw furnace is equal to or greater than ten centimeters.

16. The multi-stage draw tower of claim 13, wherein a length of the optical fiber drawn by the two or more draw stages from the preform is equal to or greater than five kilometers.

17. The multi-stage draw tower of claim 13, wherein a length of the optical fiber drawn by the two or more draw stages from the preform is equal to or greater than fifty kilometers.

18. A method comprising:
placing a preform in a multi-stage draw tower, wherein the multi-stage draw tower comprises:
two or more draw furnaces associated with two or more draw stages; and
one or more pullers to draw the preform through the two or more draw stages; and
performing a single draw process on the preform with the multi-stage draw tower, wherein the two or more draw furnaces and the one or more pullers are configured to progressively decrease a diameter of a preform through one or more intermediate diameters to provide a fiber with a selected final diameter in the single draw process.

19. The method of claim 18, further comprising:
applying pressure to the preform prior to a first of the two or more draw stages with a pressure system.

20. The method of claim 19, wherein applying pressure to the preform prior to the first of the two or more draw stages with the pressure system comprises:
applying different pressures to different portions of the preform with the pressure system.

21. The method of claim 18, further comprising:
generating monitoring data associated with at least one of the preform or the fiber with one or more monitoring sensors.

22. The method of claim 21, further comprising:
receiving the monitoring data from the one or more monitoring sensors; and
controlling, via control signals, at least one of the two or more draw furnaces or the one or more pullers based on the monitoring data.

23. The method of claim 22, wherein controlling, via control signals, at least one of the two or more draw furnaces or the one or more pullers based on the monitoring data comprises:
controlling, via control signals, at least one of one or more pullers based on the monitoring data to maintain a selected diameter of at least one of the preform or the fiber after a selected draw stage.

24. The method of claim 21, wherein the monitoring data comprises:
at least one of a diameter, a temperature, a draw speed, a tension, or a geometry.

25. The method of claim 24, further comprising:
applying different pressures to different portions of the preform with the pressure system.

26. The method of claim 25, further comprising:
receiving the monitoring data from the monitoring system; and
controlling, via control signals, at least one of the two or more draw furnaces, the one or more pullers, or the pressure system based on the monitoring data.

27. The method of claim 18, further comprising:
coating the fiber with one or more coatings with a coating system.

28. The method of claim 18, wherein the two or more draw stages comprise three or more draw stages.

29. The method of claim 18, wherein the fiber comprises:
a hollow-core fiber.

30. The method of claim 29, wherein a first draw furnace of the two or more draw furnaces is configured to accept the preform, wherein an allowable width of the preform accepted by the first draw furnace is equal to or greater than two centimeters.

31. The method of claim 29, wherein a first draw furnace of the two or more draw furnaces is configured to accept the preform, wherein an allowable width of the preform accepted by the first draw furnace is equal to or greater than ten centimeters.

32. The method of claim 29, wherein a length of the optical fiber drawn by the two or more draw stages from the preform is equal to or greater than five kilometers.

33. The method of claim 29, wherein a length of the optical fiber drawn by the two or more draw stages from the preform is equal to or greater than fifty kilometers.

34. A hollow-core optical fiber comprising:
a cladding;
one or more walled features within an interior cavity of the cladding, wherein the one or more walled features are configured to guide light of one or more selected wavelengths within a hollow central region of the interior cavity based on anti-resonance, wherein the hollow-core optical fiber is formed by the steps of:
placing a preform in a multi-stage draw tower, wherein the multi-stage draw tower comprises:
two or more draw furnaces associated with two or more draw stages; and
one or more pullers to draw the preform through the two or more draw stages; and
performing a single draw process on the preform with the multi-stage draw tower, wherein the two or more draw furnaces and the one or more pullers are configured to progressively decrease a diameter of a preform through one or more intermediate diameters to provide the hollow-core optical fiber with a selected final diameter in the single draw process.

35. The hollow-core optical fiber of claim 34, wherein a width of the preform is equal to or greater than two centimeters.

36. The hollow-core optical fiber of claim 34, wherein a width of the preform is equal to or greater than ten centimeters.

37. The hollow-core optical fiber of claim 34, wherein a length of the hollow-core optical fiber drawn by the two or more draw stages from the preform is equal to or greater than five kilometers.

38. The hollow-core optical fiber of claim 34, wherein a length of the hollow-core optical fiber drawn by the two or more draw stages from the preform is equal to or greater than fifty kilometers.
